(19) United States
(12) Patent Application Publication
(10) Pub. No.: US 2013/0239886 A1
(43) Pub. Date: Sep. 19, 2013

(54) Stencil for locating openings for electrical conduits and electrical conductors

(71) Applicant: David Wheeler, Spotsylvania, VA (US)

(72) Inventor: David Wheeler, Spotsylvania, VA (US)

(21) Appl. No.: 13/385,963

(22) Filed: Mar. 19, 2012

(51) Int. Cl. B05C 21/00

(52) U.S. Cl. 118/505

(57) ABSTRACT

A device for locating holes in an electrical box comprising a stencil including hole through the center point of the stencil, whereby a mark can be made on the surface of the electrical box, through the hole at the center point of the stencil. The stencil further includes a circular outline marked on the surface of the stencil, corresponding to the diameter of the hole to be made through the electrical box. A mark concentrically surrounding the circular outline, corresponds to the required clearance for a electrical connection to the box. In use, the operator merely has to attach the stencil to the surface of the electrical box, and easily locate the center of a hole to be made in the box, and simultaneously determine if the hole is located at a point where there is adequate clearance for an electrical collar.

### CROSS REFERENCE TO RELATED APPLICATIONS

None

### STATEMENT REGARDING FEDERALLY SPONSORED RESEARCH OR DEVELOPMENT

None

### THE NAMES OF PARTIES TO A JOINT RESEARCH AGREEMENT

None

### INCORPORATION-BY REFERENCE OF MATERIAL SUBMITTED ON A COMPACT DISK

None

### BACKGROUND OF THE INVENTION

Electrical boxes, such as breaker boxes and transformer boxes, frequently require openings to be punctured through the box for installation of electrical conduits and electrical conductors. Metallic collars are conventionally installed through the opening in the electrical box, and secured to the box. Conductors are passed through the metallic collar. Normally, the opening for the metallic collar is located by measuring, thereby locating the center point of the opening. Then the hole or opening is drilled, or punched out. The installer must estimate the clearance necessary for the metallic collar when measuring for the location of the hole. This is a tedious process, fraught with opportunities to drill or punch a hole in an inappropriate location, with insufficient clearance between other openings or other wiring in the box.

There exists a need for a simple way to locate the center point of openings in electrical boxes that will provide adequate clearance in a rapid manner.

### BRIEF SUMMARY OF THE INVENTION

The present invention provides a fool proof stencil which may be secured to the electrical box in such a manner that the installer cannot fail to provide adequate clearance for the collar and electrical conductor. The stencil has sufficient diameter to account for the opening, as well as the proper clearance between any collar or conductor.

### BRIEF DESCRIPTION OF THE SEVERAL FIGURES OF THE DRAWINGS

FIG. 1 shows the stencil according to the invention, in the manner it would be utilized with a standard electrical box.

FIG. 2 shows an embodiment of the stencil according to the invention, in the form of a square.

FIG. 3 shows an embodiment of the stencil according to the invention, in the form of a circle.

FIG. 4 shows an embodiment of the stencil according to the invention, in the form of an octagon.

FIG. 5 shows an embodiment of the stencil according to the invention, in the form of a strip for the location of a plurality of holes on a standard electrical box.

FIG. 6 shows the embodiment of FIG. 5 in an edge view.

### DETAILED DESCRIPTION OF THE INVENTION

New electrical installations require openings be made in the boxes where electrical connections are located. The openings must not only be appropriate for the electrical collar that surrounds the electrical conductor, but the opening must also account for the clearance for the collar and any adjacent collars. This process involves measuring along two perpendicular axis, and locating the center point for the opening that is to be made in the box. When locating the center point, the installer must account for adequate clearance for the collar that is used to secure the electrical conductor through the opening. This is a tedious and time-consuming process. The conventional process also presents a greater opportunity for the installer to locate holes in inappropriate places, either due to improper sizing of the holes, or a failure to provide adequate clearance between holes.

Retrofitting additional conductors to an existing box is also a time consuming and tedious process. Errors are often made, where holes are provided in locations where ultimately the collars do not have adequate clearance, perhaps necessitating replacement of the electrical box or transformer case.

The present invention provides a simple, one-piece stencil that attaches to the metallic box. The stencil includes a center-point hole through which the center point of the hole to be made can be marked on the electrical box or transformer case. An outline of the entire hole, as well as a perimeter that is dimensioned to provide an appropriate clearance for the electrical conductor and electrical collar can also be measured and marked on the surface of the electrical box or transformer case.

In the preferred embodiment, the stencil is constructed from a flexible material that magnetically attaches to the metallic electrical box. However, it is expressly understood that any method of attaching the stencil is within the scope of the invention, such as an adhesive, as with the conventional Post-It® adhesive paper. Any material that can be removabley attached to the electrical box is within the scope of the present invention and claims.

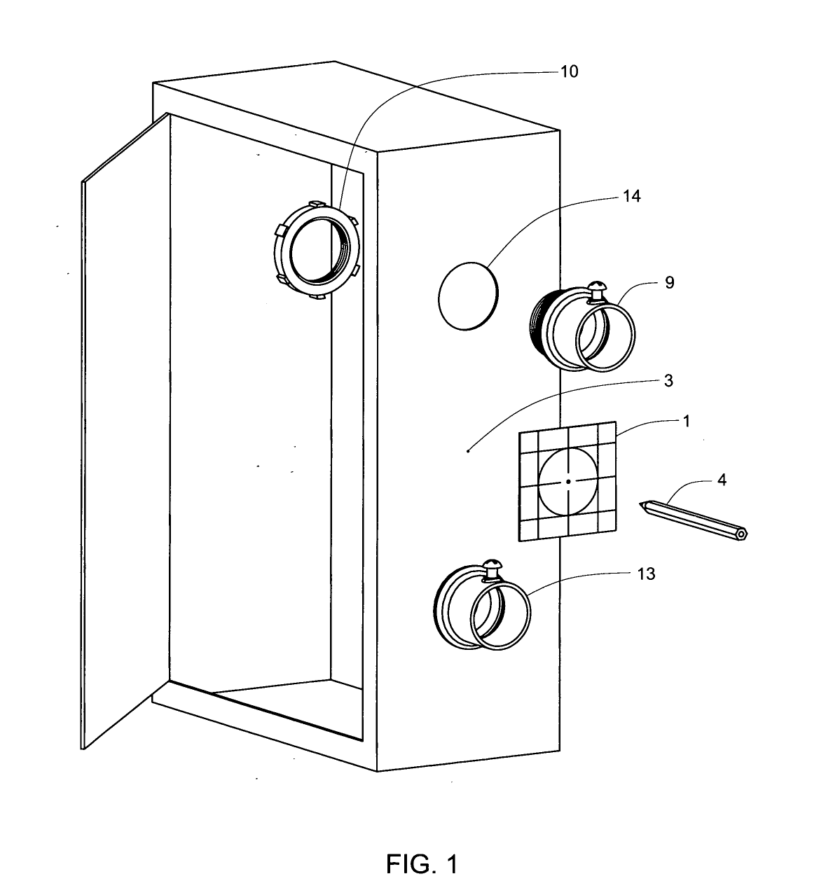

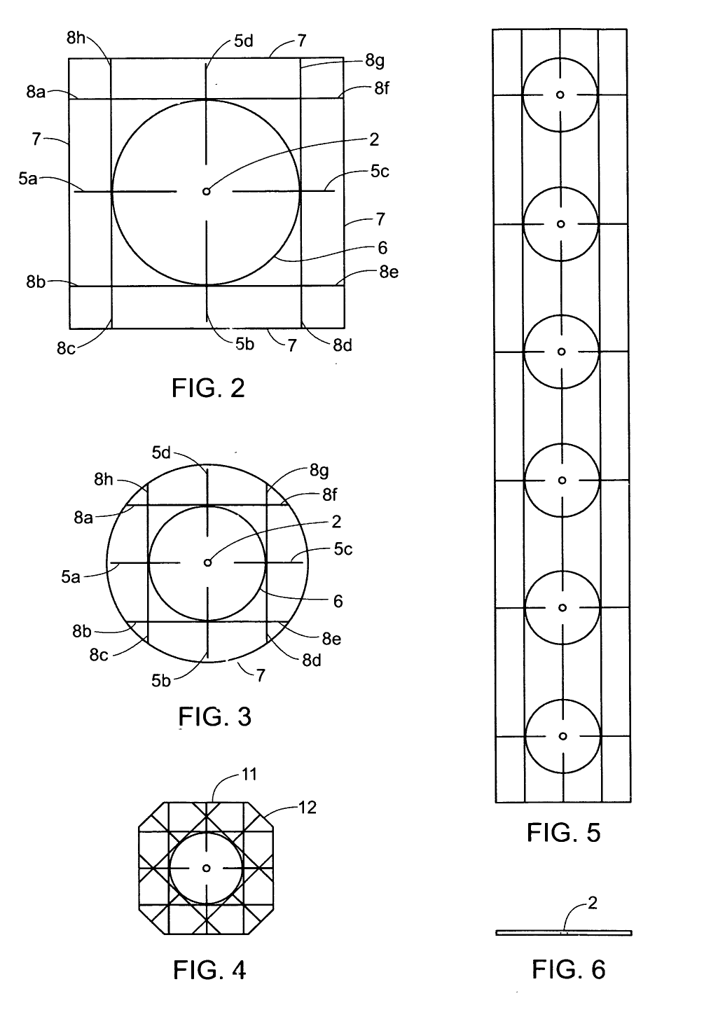

Referring to FIG. 1, a square stencil (1) is shown. Center-point (2), best seen in FIG. 2, is located in the center of the stencil. A small opening through the stencil is located at the center-point (2), through which mark (3), seen in FIG. 1, has been made be made by the installer on the surface of the electrical box, with a marker (4) such as a Sharpie® pen. Cross-hair like markings (5a) through (5d) are located on the stencil, as seen in FIG. 2, and aid in locating the correct position of the hole to be cut in the box. A circular outline (6) of the hole to be made through the box, concentrically surrounds the center-point (2). Perimeter (7) surrounds the outline (6) of the hole to be made. Points (8a) through (8h) are formed by the intersection of lines perpendicular to perimeter (7) and tangent to circular outline (6). Points (8a) through (8h) also aid in positioning the hole in the box.

As seen in FIG. 1, the circular outline (6) is dimensioned to correspond to the outer diameter of electrical collar elements (9) and (10) that are interposed between the hole in the electrical box and the conductor. Also, the perimeter (7) is appropriately dimensioned to correspond to the proper clearance between electrical collars.

FIGS. 2 through 6 show alternate embodiments of the instant invention.

FIG. 2 illustrates a square stencil as seen in FIG. (1). Small hole (2) is the center-point of the stencil, through which a mark can be made on the surface of the electrical box. Circular outline (6) corresponds to the outer diameter of an electrical collar. Perimeter (7) corresponds to the proper clearance between electrical collars located on the box. Points (5a) through (5d) are cross-hair like markings on the surface of the stencil to aid in positioning the stencil. Points (8a) through (8h) also provide optical aid to the user to properly position the stencil.

FIG. 3 shows a round stencil according to the present invention. The round stencil is the preferred embodiment.

FIG. 4 shows an octagonal stencil. The perimeters are not regular, that is the length of the perimeter alternates by every-other side. By rotating the stencil, it is possible to provide two different clearances, for two different sizes of collars. A square stencil has the corners of the square cut so that distance (12), perpendicular to the short perimeters, is longer than distance (11), perpendicular to the long perimeter sections. When the stencil is aligned with distance (12) pointing towards the adjacent structural features found on the electrical box, or other openings, a larger clearance is provided than when distance (11) faces adjacent structural features in the electrical box. In this manner, two clearances may be measured with one stencil

It is of course possible to provide stencils that have numerous holes on one stencil, as seen in FIG. 5. Several holes can be provided along one center-line, or a two-dimensional grid of center-holes can be provided along perpendicular center-lines. With this embodiment, many holes can be located simultaneously in an expeditious manner.

FIG. 6 shows the embodiment of FIG. 5 from a side view. Hole 2 is seen to penetrate through the stencil through which a center mark can be easily located on the surface of the electrical box or transformer case.

It is contemplated that a kit can be provided, with stencils appropriate for diverse electrical collars and conductors. The installer need only select the proper stencil, which is clearly marked to correspond to particular collars, place the stencil on the box, such as magnetically, and mark the center of the hole. The stencil is removed, and a hole of the correct diameter drilled or punched into the box. Of course, the stencil shows the proper outline of the hole, to eliminate the possibility of making a hole of an improper size. Any improper clearance is eliminated, because the stencil will not fit in a location where there is not adequate clearance.

The manner of using the invention is very simple. As seen in FIG. 1, an electrical collar is to be located and attached to the box. A collar is already installed as shown as (13). First, stencil (1) is magnetically attached to the electrical box. The stencil is specific to the electrical collar to be installed. The stencil is properly aligned using the marks located on the stencil. Using a pen or other device, a mark designating the center-point of the hole to be drilled made on the surface of the electrical box. The proper clearances for the collar is automatically accounted for by the stencil. The stencil is then removed from the electrical box, and a hole drilled, punched, or otherwise provided. A finished hole is seen as (14) in FIG. 1, with the elements (9) and (10) of the electrical collar to be assembled through the hole.

To make the invention, a suitable material that can be removabley attached to the electrical box is cut to the desired perimeter. Markings are embossed, printed, or otherwise permanently made on the surface of the stencil. A center hole is punched, drilled, or otherwise made through the stencil. The center hole is of a size to accommodate the point of a pen or other marking or scribing instrument. Alternatively, a plurality of stencils can be marked on a single sheet, and the sheet cut into individual stencils.

1. A device for locating holes in an electrical box comprising a stencil including hole through the center point of the stencil, whereby a mark can be made on the surface of the electrical box, through the hole at the center point of the stencil, the stencil further including a circular outline marked on the surface of the stencil, corresponding to the diameter of the hole to be made through the electrical box, and a mark concentrically surrounding the circular outline, the concentrically surrounding circular outline corresponding to the required clearance for a electrical connection to the box.

2. The device of claim 1 wherein the stencil magnetically attaches to the electrical box.

3. The device of claim 1 wherein the stencil attaches removabely to the electrical box with an adhesive.

4. The device of claim 1 wherein the stencil is in the shape of a circle.

5. The device of claim 1 wherein the stencil is square shaped.

6. The device of claim 1 wherein the stencil is in the shape of an octagon.

7. The device of claim 1 further including cross-hair markings where the center point of the hole through the stencil is located at the intersection of the cross hairs.
